(19) United States
(12) Patent Application Publication
(10) Pub. No.: US 2026/0149072 A1
(43) Pub. Date: May 28, 2026

(54) METHOD FOR RECYCLING RECHARGEABLE BATTERIES AND RECHARGEABLE BATTERY PROCESSING SYSTEM

(71) Applicant: DUESENFELD GMBH, Wendeburg (DE)

(72) Inventor: Till BUßMANN, isernhagen (DE)

(21) Appl. No.: 18/860,095

(22) PCT Filed: Feb. 16, 2023
(86) PCT No.: PCT/EP2023/053892

§ 371 Date: Feb. 5, 2026

(30) Foreign Application Priority Data
Apr. 27, 2022 (WO) PCT/EP2022/061280

(51) Int. Cl. H01M 10/54; B09B 3/20; B09B 3/40; B09B 3/80; B09B 101/16; H01M 10/44

(52) U.S. Cl. CPC H01M 10/54; B09B 3/20; B09B 3/40; B09B 3/80; H01M 10/441; B09B 2101/16

(57) ABSTRACT

The invention relates to a method for recycling rechargeable batteries (10), in particular lithium rechargeable batteries (10) and/or sodium rechargeable batteries, which each consist of at least one galvanic element, each having two poles, and contain a conducting salt dissolved in a conducting salt solvent, comprising the steps of short-circuiting the rechargeable batteries (10) until at least 75% of the galvanic elements have a regeneration cell voltage of at most 0.3 volts, in particular at most 0.2 volts, and subsequently comminuting the rechargeable batteries (10) such that comminution material (18) is obtained.

The invention relates to a method for recycling rechargeable batteries, in particular lithium batteries or sodium batteries, which contain a conducting salt dissolved in a conducting salt solvent, with the batteries preferably each consisting of at least one galvanic element, which has two poles, and containing a conducting salt dissolved in a conducting salt solvent. In particular, the rechargeable batteries consist of a plurality of galvanic elements.

According to a second aspect, the invention relates to a rechargeable battery processing system, in particular a lithium rechargeable battery and/or sodium rechargeable battery processing system, comprising a rechargeable battery comminution plant for comminuting the rechargeable batteries so as to obtain comminuted material, and (b) a washing device for washing the comminuted material with a washing solvent so as to obtain washing liquid.

Rechargeable batteries that cannot be reused should be recycled. Recycling involves separating the substances or chemical elements present in the rechargeable batteries so that they can be reused to manufacture rechargeable batteries or for other purposes.

It is desirable that the recycling process, also known as recycling, should produce as few unwanted by-products as possible. In particular, it is desirable that the recycling process should produce as few greenhouse gases as possible, because one of the reasons for the increased use of rechargeable batteries is the desire to reduce the amount of greenhouse gases produced by the energy supply.

A variety of methods for recycling rechargeable batteries, in particular lithium rechargeable batteries, are known, but they have a comparatively large carbon footprint.

Above all, it is desirable to recycle as many of the components of the rechargeable batteries as possible so that they can be reused to manufacture rechargeable batteries. This has proven to be difficult.

The object of the invention is to improve the recycling of rechargeable batteries.

The invention solves the problem by means of a method for recycling rechargeable batteries, in particular lithium rechargeable batteries and/or sodium rechargeable batteries, each consisting of at least one galvanic element, each having two poles, and containing a conducting salt dissolved in a conducting salt solvent, comprising the steps of (a) short-circuiting the rechargeable batteries to at least 75%, in particular at least 90%, of the galvanic elements have a regeneration cell voltage of at most 0.3 volts, in particular at most 0.2 volts, and (b) then comminuting the rechargeable batteries to obtain comminuted material.

According to a second aspect, the invention solves the problem by means of a rechargeable battery processing system comprising (a) an optional rechargeable battery comminution system for comminuting the rechargeable batteries to obtain comminuted material, and (b) a high-boiler washout device for washing out conducting salt solvent, in particular a high-boiler fraction of the conducting salt solvent, from the comminuted material by means of a high-boiler fraction solvent, so that a high-boiler/solvent mixture and comminuted material low in high-boilers is obtained.

The invention also solves the problem by a method comprising the steps of (a) comminuting the rechargeable batteries to obtain comminuted material, (b) washing out conducting salt solvent by means of a high-boiler fraction solvent, in particular by means of a low boiler fraction of the conducting salt solvent, (c) then drying the comminuted material, the high-boiler fraction of which has been washed out by means of the high-boiler fraction solvent, at a temperature of at most 70° C., preferably at most 60° C., in particular at most 50° C., and a pressure of at most 300 hPa, in particular at most 100 hPa, preferably at most 10 hPa, and (d) then separating plastic parts, in particular plastic foil parts, and/or metal foil parts. In this way, the formation of significant quantities of hydrogen fluoride is prevented and the separation of the plastic parts and/or the metal foil parts is facilitated. The reason for this is that the high-boiler fraction adheres the plastic parts and/or the metal foil parts to other components, in particular graphite particles and/or particles containing metal components, which makes the separation more difficult. This process preferably has step (a) of claim 1. Preferred embodiments mentioned for the other aspects of the invention also apply to this invention. In particular, the pressures indicated do not have to be constantly below these values.

In the context of the present description, the binder of the cathode is understood to be the binder of the cathode. The cathode of the accumulator is the cathode during discharge.

An alkali metal battery is understood to be a battery in which an alkali metal, in particular sodium or lithium, or a compound of an alkali metal migrates from one electrode to the other during the release of electrical energy. It is possible, but not necessary, that the oxidation and/or charge of the alkali metal change in the process.

An alkali metal battery is also specifically understood to mean an alkali metal rechargeable battery. A rechargeable battery is understood to mean a rechargeable battery. A lithium battery is specifically understood to mean a lithium rechargeable battery, i.e. a battery.

Examples of alkali metal batteries are lithium-ion rechargeable batteries such as lithium-cobalt dioxide rechargeable batteries, lithium-polymer rechargeable batteries, lithium-manganese rechargeable batteries, lithium-nickel-cobalt-manganese rechargeable batteries, lithium-iron phosphate rechargeable batteries, lithium-iron-yttrium phosphate rechargeable batteries, lithium titanate rechargeable battery, lithium metal polymer rechargeable battery and lithium rechargeable batteries with metallic lithium, as well as lithium-air rechargeable batteries, lithium-sulphur rechargeable batteries, sodium nickel chloride high-temperature batteries, sodium-sulphur rechargeable batteries and sodium-ion rechargeable batteries.

The comminuted material is understood to be the material that is produced by comminuting the alkali metal batteries.

When the washing out of a conducting salt is mentioned, it is also understood that the anion of the conducting salt is removed. Instead of washing out the conducting salt, it can also be said that the anion of the conducting salt is washed out.

When graphite is mentioned, other carbon configurations can always be included in a generalization of the invention.

The conducting salt solvent preferably contains ethyl methyl carbonate (EMC), i.e. ethyl methyl carbonate (EMC), and/or dimethyl carbonate (DMC), i.e. dimethyl carbonate (DMC), and/or ethylene carbonate

Short-circuiting the rechargeable batteries makes it easier to recover the conducting salt or the anion of the conducting salt and/or the lithium. Why this is so is not fully understood. Presumably, a regeneration cell voltage that is well above 0 V causes heat to build up locally during comminution, which can promote the decomposition of the conducting salt and/or the formation of hydrogen fluoride. In addition, after a long short circuit, a maximum amount of lithium is present in metallic form and not as an ion.

It should be noted that a deep discharge alone does not lead to a regeneration cell voltage of 0.2 V at most. A deep discharge is understood to mean a current drain from the rechargeable battery until its capacity is almost completely exhausted, in particular until it falls below the final discharge voltage. The energy content of the rechargeable battery is very low after deep discharge, because on the one hand the cell voltage has dropped considerably and on the other hand the achievable discharge current is very low. Therefore, state-of-the-art processes only perform deep discharges.

However, it has been found that even after a deep discharge, the energy content is sufficiently high to be able to lead to the formation of hydrogen fluoride. The quantities of hydrogen fluoride that are produced during comminution of deeply discharged, but not short-circuited, rechargeable batteries are comparatively small. However, it has been found that even small amounts of impurities of the conducting salt and/or the electrolyte with decomposition products can impair the suitability for manufacturing new rechargeable batteries.

It has also been shown, somewhat surprisingly, that deep discharge can make lithium, if present, easier to extract. This is because the lithium (which is usually present in ionic form) is hardly or not unintentionally removed during the process steps for removing other components.

The regeneration cell voltage is the cell voltage present at the respective galvanic element after a specified regeneration time during which the poles of the rechargeable battery are electrically disconnected. The fact that the poles of the rechargeable battery are electrically disconnected means that the poles are insulated from each other, i.e. in particular that there is a resistance of at least 1 megohm between the two poles. In other words, no electrical energy is taken from the galvanic cell during the regeneration time. In particular, the poles of the galvanic cells of the rechargeable battery are electrically unconnected during the regeneration time.

During the regeneration time, the cell voltage increases. Even discharging a rechargeable battery to a final charging voltage of, for example, below 0.2 V will result in a regeneration cell voltage of more than 0.2 V, unless the discharging or short-circuiting is carried out for a sufficiently long time.

It was determined that a rechargeable battery INR18650-25R from Samsung, manufactured in February 2022, has a cell voltage of 0 V after being short-circuited for 1 hour. The regeneration cell voltage was 1 V. After being short-circuited for 3 hours, the cell voltage was 0 V, and the regeneration cell voltage was 0.8 V. After short-circuiting for 5 hours, the cell voltage was 0 V, the regeneration cell voltage was 0.6 V. After short-circuiting for 24 hours, the cell voltage was 0 V, the regeneration cell voltage was 0.2 V.

Short-circuiting the rechargeable batteries for such a long time that the regeneration cell voltage is at most 0.4V, in particular at most 0.3 V, in particular at most 0.2 V, and particularly preferably at most 0.1 V, is also referred to as regeneration-proof short-circuiting. It is therefore favorable to comminute the rechargeable batteries only after they have been short-circuited in a regeneration-proof manner.

Whether or not regeneration-proof short-circuiting has taken place can be determined by storing the corresponding rechargeable battery for the regeneration time without an external electrical load and, in particular, without short-circuiting at 1013 hPa and 23° C. In other words, short-circuiting the rechargeable batteries can occur even if the rechargeable batteries are comminuted or otherwise processed before the end of the regeneration time, provided that at least 75% of the galvanic elements have the specified maximum regeneration cell voltage. The only thing that matters is whether they have been short-circuited in such a way that they would not exceed the specified regeneration cell voltage after the regeneration time has elapsed.

The regeneration time is 12 hours. It should be noted that this is not a statement about how long the rechargeable batteries are short-circuited. In particular, short-circuiting the rechargeable batteries for 12 hours can cause the regeneration cell voltage to exceed 0.2 volts.

Preferably, the rechargeable batteries are short-circuited for a short-circuit time of at least 8 hours, in particular at least 10 hours, preferably at least 12 hours, particularly at least 15 hours, in particular at least 18 hours. A short-circuit time of at least 20 hours, for example 24 hours, is particularly favorable. Preferably, the short-circuit time is less than 120 hours. In this way, it can be achieved that-as provided for in a preferred embodiment-at least 90 percent by weight, in particular at least 95 percent by weight, of the conducting salt of the rechargeable battery does not decompose during comminution.

Preferably, the comminuting is carried out in such a way that at least 90 mol %, in particular at least 95 mol %, and preferably at least 99 mol %, of the fluorine components of the rechargeable batteries remain in the comminuted material. In particular, preferably no substance is added, in particular no water, that drives off fluorine as a gaseous compound.

It is favorable for the short-circuiting to be carried out with a metallic conductor. The metallic conductor connects the poles of the rechargeable battery, i.e. the negative pole and the positive pole, without load. This means that the metallic conductor does not connect the poles of the rechargeable battery to an electrical resistor or any other electrical load. In particular, it is favorable if the connection of the negative pole and the positive pole is not carried out by means of a liquid, in particular a salt solution.

Preferably, when short-circuiting, an electrical resistance between the positive terminal of the rechargeable battery and a negative terminal of the rechargeable battery is at most 10 ohms, in particular at most 1 ohm, preferably at most 0.3 ohm.

It is possible, but not necessary, that the rechargeable battery is transported after regeneration-proof short-circuiting, in particular over a distance of at least 1 km, in particular at least 5 km. The risk of fire and thus of environmental hazard from the rechargeable battery is particularly low due to the regeneration-proof short-circuiting. Preferably, the rechargeable battery is not transported over a distance of more than 1 km after regeneration-proof short-circuiting, since such transportation can also pose a safety risk.

Preferably, the method comprises, after short-circuiting and—in accordance with one embodiment, before any washing out of conducting salt solvent—the step of drying the comminuted material at a temperature of at most 80° C., in particular at most 70° C., particularly preferably at most 60° C., for example at most 50° C. Preferably, the drying is carried out at a pressure of at most 300 hPa, in particular at most 50 hPa, particularly preferably at most 10 hPa, so that dried comminuted material is obtained.

Preferably, at least 40 wt. %, in particular at least 50 wt. %, preferably at least 60 wt. %, particularly preferably at least 70 wt. %, of the solvent of the electrolyte is removed by the drying. Preferably, at most 95% by weight of the solvent of the electrolyte is removed, in particular at most 90% by weight, preferably at most 85% by weight.

After the comminuting step and, if appropriate, after the drying step, the method comprises, in accordance with an embodiment, the step of separating plastic parts, in particular plastic foil parts, and/or metal foil parts. This is done, for example, by mechanical separation. The mechanical separation is, for example, a classifying. The metal foil parts are understood to be, in particular, aluminum foil parts and/or copper foil parts. Preferably, at least 50 percent by weight, in particular at least 65 percent by weight, most preferably at least 80 percent by weight, of the plastic parts are separated.

The process preferably comprises the step of washing out conducting salt solvents using a high-boiler fraction solvent. The high-boiler fraction solvent preferably contains at most 1% by weight, in particular at most 0.1% by weight, of components whose boiling point is higher than a separation boiling point. The separation boiling point is preferably between 120° C. and 150° C., in particular 150° C. The separation boiling point refers to normal pressure (1013 hPa).

Preferably, the high-boiler fraction solvent is chosen such that it does not react with the conducting salt during washing. In one embodiment, the high-boiler fraction solvent is chosen so that it does not form a compound with lithium during washing.

The aim of washing out conducting salt solvent is, in particular, to wash out a high-boiler fraction of the conducting salt solvent. Thus, when speaking of washing out conducting salt solvent, one could also speak of washing out the high-boiler fraction.

According to a preferred embodiment, the high-boiler fraction solvent contains at least 80 wt. %, in particular at least 90 wt. %, of substances that are contained in the conducting salt solvent and have a boiling point above the separation boiling point. For example, the high-boiler fraction includes ethylene carbonate and/or propylene carbonate.

The high-boiler fraction solvent is preferably obtained by distilling, in particular vacuum distilling, conducting salt solvents. In the vacuum distillation, a temperature of 80° C., in particular 70° C., preferably 60° C., particularly preferably 50° C., in particular 45° C., is not exceeded.

In particular, it is preferred that the high-boiler fraction solvent is regenerated and/or recirculated. The high-boiler fraction is removed from the high-boiler fraction solvent, for example by distillation, and the remaining low-boiler fraction is used as high-boiler fraction solvent.

The fact that the higher boiler fraction solvent is regenerated means, in particular, that the regenerated higher boiler fraction solvent is at least partially reintroduced into the comminuted material for washing out the high-boiler fraction. In other words, the high-boiler fraction solvent is at least partially recycled.

When components of the conducting salt solvent are used to wash out the conducting salt solvent, the high boilers are removed to a very great extent, in particular at least 90 percent by weight, preferably almost completely, in particular at least 97 percent by weight. High boilers are substances of the conducting salt solvent with a boiling point above the separation boiling point T_{S,t}.

Alternatively, instead of the low-boiling fraction, a solvent that is not part of the conducting salt solvent can be used to wash out the conducting salt solvent. In this case, it is advantageous if the solvent has a boiling point of at most 150° C., in particular at most 110° C., at normal pressure. For example, acetone is suitable.

Preferably, no alkaline earth metal hydroxide is used when washing out the conducting salt solvent. In particular, no more than one percent by weight of the lithium reacts with alkaline earth metal hydroxide.

Preferably, the washing out of the conducting salt solvent is carried out in such a way that at most one third (in percent by weight) of the conducting salt is washed out. In other words, the high-boiler fraction solvent does not extract any conducting salt. Alternatively or additionally, the washing out of the conducting salt solvent is preferably carried out in such a way that at most one third of the anion of the conducting salt (in mol percent) is washed out.

In one embodiment, the conducting salt is not removed together with the high-boiler fraction. In this case, the ratio Q_{Ak} of the weight of the high-boiler to the weight of the conducting salt in the rechargeable batteries is preferably at least twice as large, in particular at least three times as large, as the ratio Q_{SF} in the high-boiler fraction. In other words, during the washing out with the conducting salt solvent, the higher boilers in the conducting salt solvent are predominantly removed from the comminuted material.

The higher boiler fraction solvent is preferably an organic solvent. In particular, the higher boiler fraction solvent is preferably essentially free of water. This means that a water content is at most 1 percent by weight.

The process preferably comprises the steps of (a) introducing the low-boiler fraction into the comminuted material to form a low-boiler/solvent mixture, i.e. the mixture of low-boilers with the solvent, (b) optionally introducing mechanical energy, for example by stirring, shaking or ultrasound, into the comminuted material, (c) withdrawing the low-boiler/solvent mixture and (d) producing the low-boiler fraction by distillation, whereby a high-boiler fraction is formed. The low boiler fraction is used as the high-boiler fraction solvent. Any excess low-boiler fraction is drawn off and can be reused for the production of rechargeable batteries, optionally after purification, for example by distillation. The high-boiler fraction is drawn off and can be reused for the production of rechargeable batteries, optionally after purification, for example by distillation, crystallization or solvent extraction.

The process preferably comprises the step of: after washing out the conducting salt solvent, in particular the high-boiler fraction of the conducting salt solvent, drying the comminuted material at a temperature of at most 80° C. and a pressure of at most 300 hPa, in particular at most 100 hPa, preferably at most 10 hPa, so that comminuted material with a low content of high boilers is obtained. The drying process removes a large proportion, in particular at least 80 percent by weight, preferably at least 90 percent by weight, particularly preferably at least 95 percent by weight, of the high-boiler fraction solvent, in particular the low-boiler fraction of the conducting salt solvent. This reduces the adhesion between the individual particles of the comminuted material, which facilitates further processing, for example any subsequent separation.

In one embodiment of the method, no water is added to the comminuted material until it has dried. This avoids a reaction of the conducting salt and/or other components of the electrolyte with water.

The process preferably includes the step of separating plastic components, in particular plastic foil parts and/or metal foil parts of the low-boiling comminuted material. This increases the concentration of valuable components, in particular graphite and heavy metals. In addition, the plastic components do not dissolve during any subsequent binder removal and thus contaminate the separated binder.

The rechargeable batteries that are reused contain a binder that is used to bind graphite particles to each other and to an electrode, in particular the anode. After washing out the conducting salt solvent and, if necessary, after separating plastic components, in particular plastic foil parts and/or metal foil parts, binder is washed out, preferably using a binder solvent. In one embodiment, the washing out of the binder is carried out at a temperature of at least 80° C., in particular at least 90° C., preferably at least 100° C. It is possible, but not necessary, for the washing out of the binder to be carried out under positive pressure. It is advantageous that the binder can be recovered without decomposition.

In one embodiment, the binder solvent contains hydrogen fluoride precipitating substances or the binder solvent is brought into contact with a hydrogen fluoride precipitating substance. Preferably, no alkaline earth metal hydroxide is used in the washing out of the binder. In particular, at most one percent by weight of the lithium reacts with alkaline earth metal hydroxide.

It has surprisingly been found that the conducting salt solvent or substances of the conducting salt solvent, such as the low-boiler fraction, is suitable for washing out the binder at sufficiently high temperatures, for example at least 80° C. Preferably, the binder solvent consists of at least 50 percent by weight, in particular at least 70 percent by weight, preferably at least 80 percent by weight, particularly preferably at least 90 percent by weight, of substances that are components of the conducting salt solvent. In particular, the binder solvent is obtained by washing out the comminuted material.

According to the invention, a method for recycling rechargeable batteries, in particular lithium rechargeable batteries and/or sodium rechargeable batteries, each consisting of at least one galvanic element, each having two poles, and containing a conducting salt dissolved in a conducting salt solvent, is therefore also (a) comminuting the rechargeable batteries to obtain comminuted material and (b) washing out binder from the comminuted material by means of a binder solvent which consists to the extent of at least 50 percent by weight, in particular to the extent of at least 60 percent by weight, particularly preferably to the extent of at least 70 percent by weight, preferably at least 80 percent by weight, in particular at least 90 percent by weight, consists of substances which are components of the conducting salt solvent, preferably belonging to the low-boiling fraction. Preferred embodiments mentioned in connection with other aspects of the invention also apply to this process.

The binder solvent may also contain or consist of a protic, in particular a protic-polar, solvent. Preferably, the binder solvent consists of at least 70 percent by weight, in particular at least 80 percent by weight, most preferably at least 90 percent by weight, of dimethyl sulfoxide.

If a protic solvent is used, the washing out of the binder is carried out in an embodiment at a temperature of at most 90° C., in particular at most 80° C., preferably at most 70° C., in particular preferably at most 60° C., for example at most 50° C. This prevents the formation of hydrogen fluoride to a significant extent. It is possible, but not necessary, that the washing out of the binder takes place under positive pressure. The significant reduction in the formation of hydrogen fluoride means, in particular, that a maximum of 3 mol-%, and in particular a maximum of 1 mol-%, of the fluorine reacts to form hydrogen fluoride during the washing out of the binder.

The binder solvent is alternatively or additionally acetone, g-butyrolactone (GBL), diethyl carbonate (DEC), dimethylacetamide (DMA), N,N-dimethylformamide (DMF), dimethyl sulfoxide (DMS O), 3-heptanone, 3-hexanone, methyl ethyl ketone (MEK), methyl ethyl ketone (MEK), methyl octanoate, supercritical carbon dioxide or a mixture of two, three, four or more of the chemical compounds mentioned.

Preferably, the washing out of the binder is carried out until at least 50 percent by weight, in particular at least 60 percent by weight, preferably at least 70 percent by weight, more preferably 80 percent by weight, of the binder has been removed.

Preferably, the binder solvent is circulated and regenerated by removing dissolved binder. For example, the process comprises the steps of (i) supplying the binder solvent to the comminuted material, which may be low in high-boilers, (ii) withdrawing the binder/solvent mixture, and (iii) separating the binder solvent and returning it to the comminuted material, which may be low in high-boilers.

The binder solvent is separated, for example, by evaporation. Alternatively or additionally, the binder solvent is separated by separating binder. This in turn is done, for example, by reducing the temperature and subsequent filtration, centrifugation or sedimentation. The binder is drawn off and the remaining binder solvent is either reused for washing out binder or is also drawn off.

After washing out the binder, the comminuted material or black mass is dried, preferably. Drying is preferably carried out at a maximum of 80° C. and/or a maximum of 300 hPa, in particular a maximum of 100 hPa, and most preferably a maximum of 50 hPa. Since the fluorine content in the comminuted material or black mass is often sufficiently low after removal of the binder, drying can also be carried out at higher temperatures without the formation of excessive amounts of hydrogen fluoride.

It is preferable not to add water when washing out the binder. It is preferable not to add water and/or aqueous liquid to the comminuted material until the binder has been removed.

According to a preferred embodiment, conducting salt or hexafluorophosphate compounds are washed out by means of an aqueous washing solvent. This is preferably done after washing out the conducting salt solvent and/or after washing out the binder.

The washing solvent may contain acid, for example an organic acid. For example, the organic acid is acetic acid or formic acid. Alternatively, the washing solvent may be basic. Preferably, the pH is at least 8. For example, the washing solvent contains ammonia or an ammonium compound.

Many rechargeable batteries contain a mixture of graphite and metal compound particles, for example NMC (nickel-manganese-cobalt) particles. These can be glued together using a binder. By removing the binder, the adhesions between the graphite and the metal compound particles are reduced to such an extent that the graphite can be separated much more easily from the metal compound particles. The graphite fraction can then be separated from the metal compound particle fraction by means of classification or flotation, for example. Classification may be a fine classification process that uses a classifier wheel.

The classifier wheel may also be referred to as a sizing wheel. The classifier wheel has recesses, in particular slots. The recesses preferably have a clear width, in particular a slot width, which is at least 0.1 mm, in particular 1 mm, and/or at most 25 mm, in particular at most 15 mm, and is particularly preferably at most 10 mm.

Preferably, the fine classifier is designed to rotate the classifier wheel at a classifier wheel rotational frequency between 500 and 20,000 revolutions per second. The higher the classifier wheel rotational frequency, the smaller the aerodynamic diameter of the removed fraction.

Preferably, the recesses and the rotational frequency are selected such that the graphite fraction has a graphite-fraction particle size distribution, wherein 80% by volume of the graphite has a particle size of less than 20 μm.

Alternatively or additionally, the recesses and the rotational frequency are selected such that the transition metal fraction has a transition metal fraction particle size distribution, with 90% of the particles having a particle size of less than 35 μm, in particular less than 30 μm. Preferably, at least 50% of the particles have a particle size of less than 25 μm, in particular less than 20 μm. It has been found that a particularly high enrichment factor can be achieved in this way. The particle size is determined according to DIN ISO 13320:2009.

In the graphite fraction, graphite is enriched relative to the metal compound particle fraction by at least a factor of 2, preferably by at least a factor of 3, more preferably by at least a factor of 4. In other words, the graphite concentration in the graphite fraction is twice, three times, or four times as high as in the metal-compound particle fraction.

It is possible, but often not necessary, to purify the graphite fraction, which can be done with sulfuric acid, for example.

According to a preferred embodiment, at least one metal component is extracted from the metal compound particle fraction by hydrometallurgical means. This can be done with a mineral acid, for example sulfuric acid, for example concentrated sulfuric acid.

However, it is not necessary that the conducting salt solvent, in particular the high-boiler fraction, is washed out before the separation of plastic foil parts. According to one embodiment, the process therefore comprises the steps of
(a) drying the comminuted material at a temperature of at most 80° C. and a pressure of at most 300 hPa, in particular at most 100 hPa, and most preferably at most 10 hPa. The product obtained in this way may be called dried comminuted material. This is followed by
(b) a separation of plastic components, in particular plastic foil parts, and/or metal foil parts. In particular, these components are separated from the dried comminuted material. The product obtained in this way can be called black mass. This is followed by
(c) a removal of binder and the high-boiler fraction by means of the binder solvent.

The above-mentioned pressure and temperature ranges and the use of a suitable binder solvent also apply to this embodiment.

It has been found, surprisingly, that less hydrogen fluoride is produced, even at temperatures above 80° C., for example, the more binder solvent is used. Therefore, at least 1 liter, preferably at least 2 liters, and particularly preferably at least 3 liters, of binder solvent are added per kilogram of black mass.

It is possible that the removal of the binder and the high-boiler fraction takes place in batch operation. In this case, the process preferably comprises the steps (a) adding the binder solvent to the black mass, in particular with the above-mentioned amount of binder solvent. The mixture of binder solvent and black mass can be accelerated to better dissolve the binder. This acceleration is an introduction of mechanical energy. For example, acceleration includes stirring, shaking and/or ultrasonic treatment.

In a subsequent step (b), the binder-solvent mixture is removed, for example by filtration, suction, centrifuging or by the introduction of a fluid. The fluid may, for example, be binder solvent.

Steps (a) and (b) are preferably repeated at least once, in particular twice, three times, four times or more.

Alternatively or additionally, the removal of the binder and the high-boiler fraction can be carried out continuously. In this case, binder solvent is added continuously and binder/solvent mixture is removed.

If the binder solvent is regenerated, as provided for in a preferred embodiment, the high-boiler fraction of the conducting salt solvent is also separated in addition to the binder. Regeneration is preferably carried out by vacuum distillation.

After washing out the binder, the conducting salt is preferably washed out, as described above, and/or the graphite fraction is separated from the metal-compound particle fraction. For example, after washing out the binder, a flotation is carried out so that both the conducting salt or its anion are washed out and, in addition, the graphite fraction is separated from the metal-compound particle fraction. The flotation is preferably carried out with an aqueous flotation liquid.

A rechargeable battery processing system according to the invention could also be called a rechargeable battery recycling system or a rechargeable battery reprocessing system. The rechargeable battery processing system according to the invention is designed to carry out a process according to the invention. It preferably has a device for each of the preferred process steps mentioned above, which is designed to carry out this process step.

The separating device comprises, for example, a classifier, in particular a fine classifier or an air classifier, or a flotation plant, for example a froth flotation plant.

Preferably, the binder leaching device has a recovery plant for recovering binder solvent. For this purpose, the recovery plant has, for example, a nutsche filter, a filter or a distillation device, in particular a vacuum distillation device. The recovered binder solvent is reused to wash out binder.

The rechargeable battery processing system preferably has a heavy boiler fraction washing out device arranged in the direction of material flow before the binder washing out device and after the rechargeable battery comminution system, which is designed to washing out a high-boiler fraction of the conducting salt solvent of the rechargeable batteries by means of the high-boiler fraction solvent, so that a high-boiler/solvent mixture and comminuted material low in high-boilers is obtained.

If the rechargeable battery processing system is designed to wash out the high-boiler fraction and the binder in separate steps, as provided for in a preferred embodiment, the high-boiler fraction washing-out device is preferably arranged in front of a dryer and in front of the plastic separating device, as seen in the direction of material flow.

It is advantageous if the rechargeable battery processing system has a regeneration device for regenerating the high-boiler fraction solvent. In particular, the regeneration device is also designed to separate the high-boiler fraction. The regeneration device can, for example, be a distillation device, in particular a vacuum distillation device. The regenerated high-boiler fraction solvent is reused for washing out. In other words, the high-boiler fraction solvent is recycled. Excess high-boiler fraction solvent is drawn off and used, for example, in the production of new rechargeable batteries.

The invention is explained in more detail below with reference to the accompanying drawings.

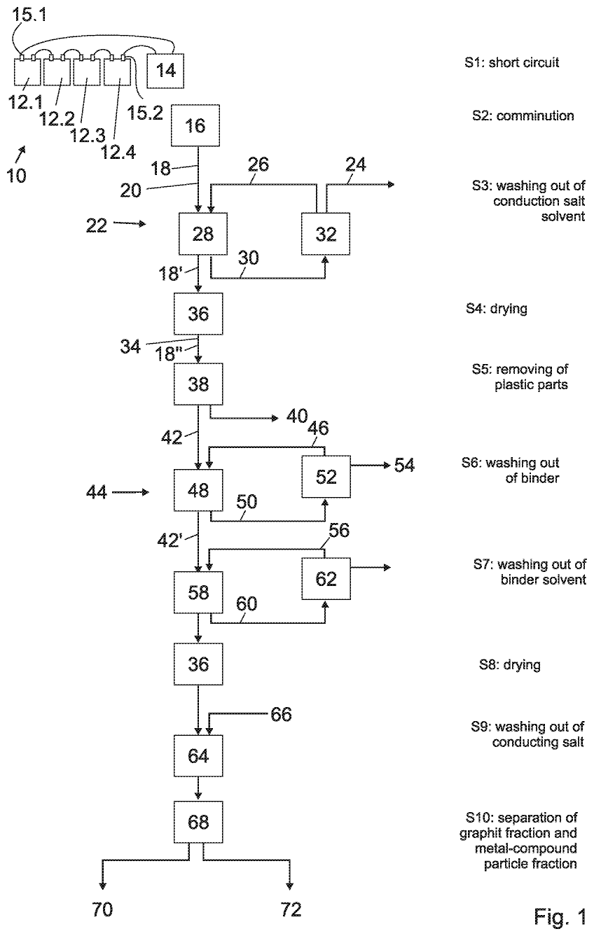

FIG. 1 shows a flow diagram of a process according to the invention in accordance with a first embodiment,

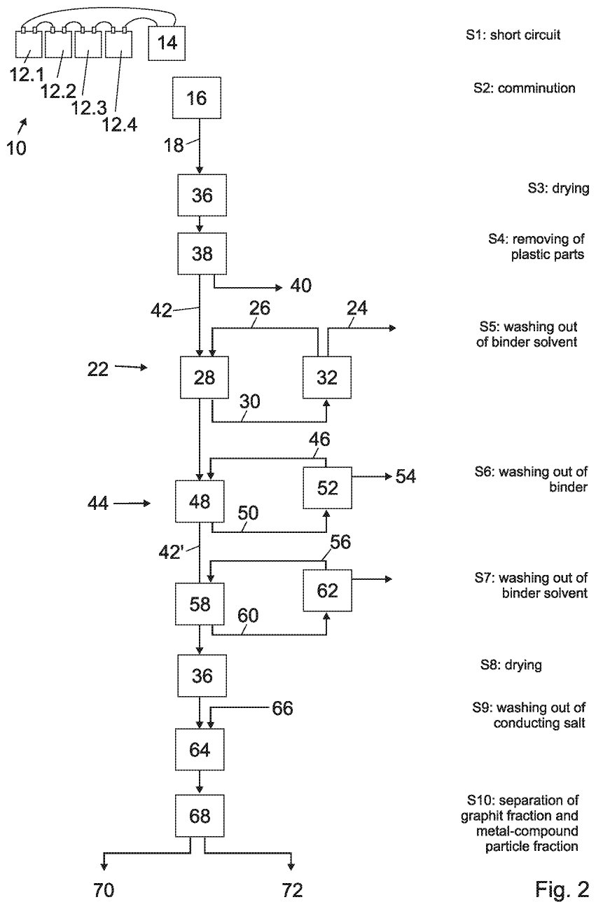

FIG. 2 shows a flow diagram of a process according to the invention in accordance with a second embodiment,

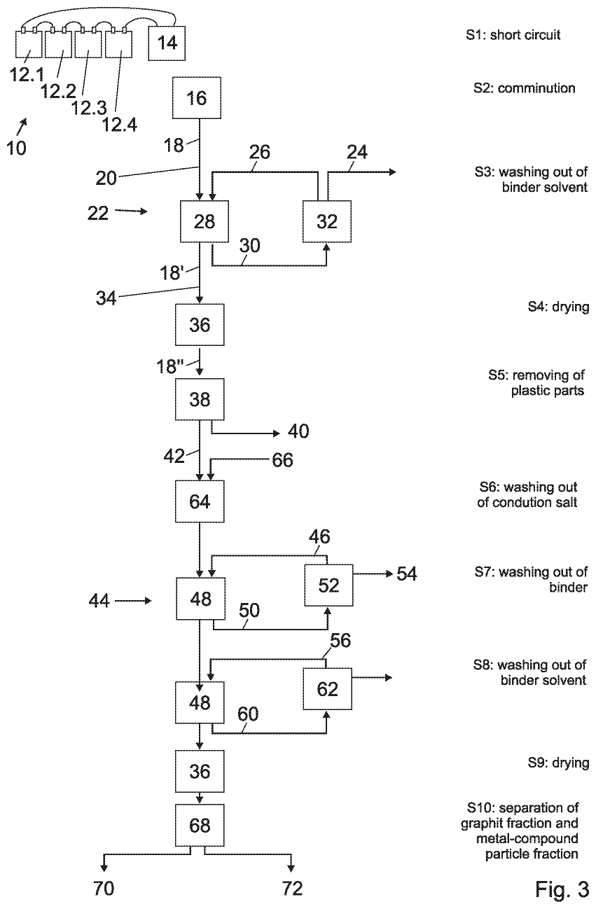

FIG. 3 shows a flow diagram of a process according to the invention in accordance with a third embodiment,

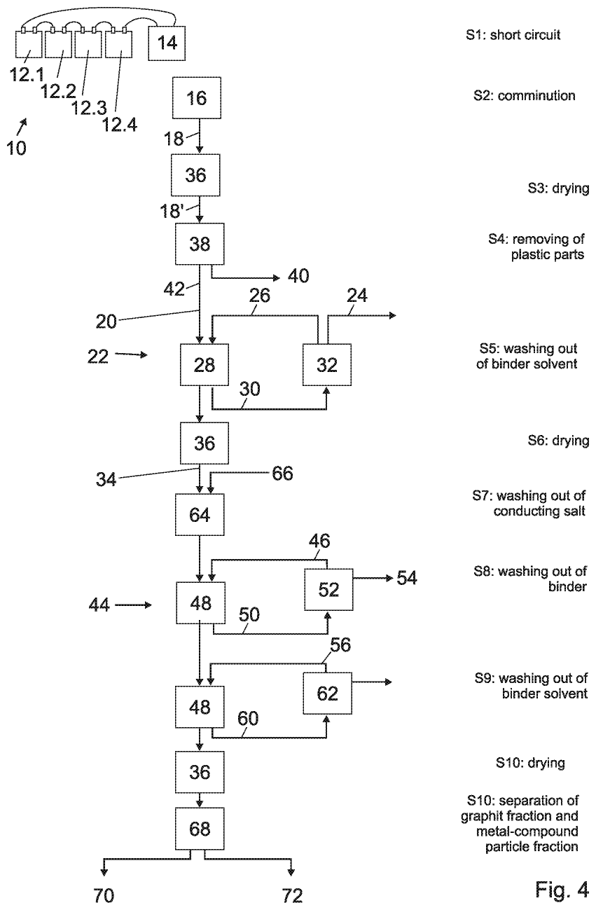

FIG. 4 a flow chart of a method according to the invention according to a fourth embodiment,

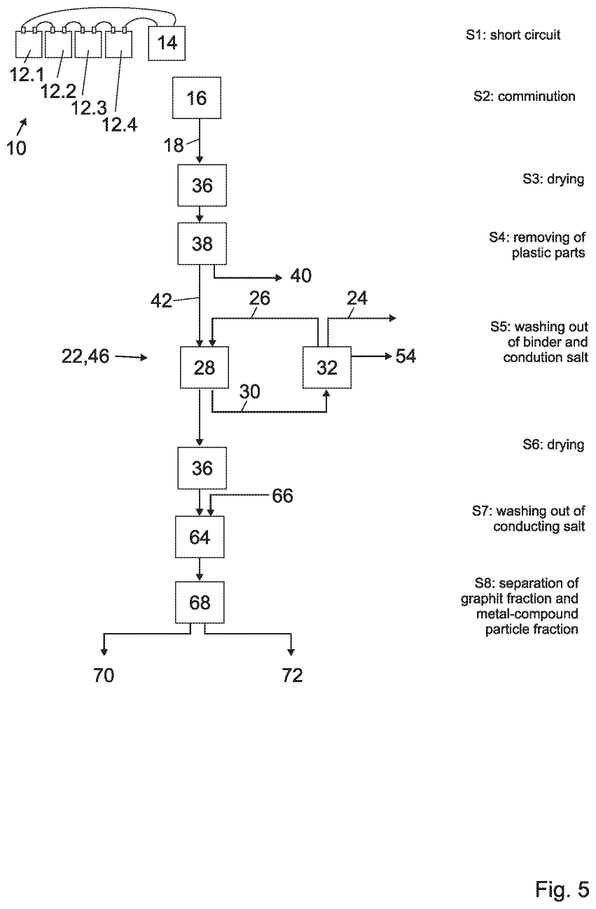

FIG. 5 a schematic representation of a rechargeable battery processing system according to the invention.

FIG. 1 shows a flow diagram of a process according to the invention and the schematic structure of a rechargeable battery processing system 8 according to the invention. First, the rechargeable batteries to be recycled, the rechargeable battery 10 is shown, which is made up of galvanic elements 12.i (i=1, 2, . . . ), are short-circuited in a step S1 by means of a discharger 14. For this purpose, a negative pole 15.1 and a positive pole 15.2 are connected to one another by means of the discharger with a resistance of preferably less than 10 ohms. The discharging is only terminated when the galvanic elements 12.i have a regeneration cell voltage U_{reg} below U_{reg}=0.3 V.

After that, the rechargeable battery 10 is comminuted in a rechargeable battery comminution system 16 in accordance with step S2, so that comminuted material 18 is obtained. The comminuted material 18 passes through a preferably dust-tight conduit 20 from the comminution plant 16 into a high-boiler fraction washout device 22. In the high-boiler fraction washout device 22, conducting salt solvent, in particular a high-boiler fraction 24, is washed out in accordance with a step S3. For this purpose, high-boiler fraction solvent 26 is added to the comminuted material 18. It is possible, but not necessary, for the high-boiler fraction washout device 22 to have a circulating device, for example a stirrer.

The high-boiler fraction solvent 26 is, for example, a conducting salt solvent by means of which a conducting salt is dissolved in the rechargeable batteries 10. The solution of conducting salt solvent and conducting salt form the electrolyte of the rechargeable battery 10.

The high-boiler fraction solvent 26 dilutes the electrolyte of the rechargeable battery 10 and thus enriches itself with the high-boiler fraction, i.e. with those substances of the conducting salt solvent that have a boiling point above a separation boiling point T_{S,t}. For example, T_{S,t}=150° C.

For example, the high-boiler fraction washout device 22 has a vessel 28 in which the comminuted material 18 is mixed with the high-boiler fraction solvent 26. This produces a high-boiler/solvent mixture 30 that can be fed to a regeneration device 32. In the regeneration device 32, the high-boiler fraction solvent 26 is separated from the high-boiler fraction 24, for example by vacuum distillation. In this way, comminuted material 18′ with a low high-boiler content is obtained.

The comminuted material 18′ that has a low content in high-boilers is fed to a dryer 36, in particular through a dust-tight, preferably gas-tight, line 34. In a step S 4, the low-boiling comminuted material 18′ is dried at a temperature of at most 80° C., in the present case at 50° C., under a pressure of, for example, 50 hPa. Drying is optional.

After drying, the dried comminuted material 18″ passes into an optional plastic separating device 38, in which plastic components 40 are separated in accordance with an optional step S5. The plastic components 40 are, for example, part of a plastic housing or parts of plastic films, in particular separator films. In addition, metal foil parts are preferably separated.

In this way, black mass 42 is obtained.

The black mass 42 passes into a binder wash-out device 44, in which a binder solvent 46 is added to the black mass 42. The binder solvent 46 may, for example, be dimethyl sulfoxide. A temperature T₄₈ in a wash-out container 48 of the binder wash-out device 44 is preferably below T₄₈=80° C. A binder-solvent mixture 50 is produced by washing out binder from the black mass 42 in accordance with step S6 using the binder solvent 46. The binder/solvent mixture 50 is either disposed of or fed to a recovery system 52 that separates the binder solvent 46 from the binder 54 by use, filtering and/or distillation.

Optionally, in a subsequent step S7, the binder solvent 46 can be washed out by means of an auxiliary solvent 56. This is done, for example, in a vessel 58, but can also be done in the washout vessel 48.

The auxiliary solvent 56 has a lower boiling point than the binder solvent 46. Preferably, the boiling points differ by at least 10 Kelvin. For example, the boiling point T56 of the auxiliary solvent 56 at normal pressure is below 120° C., in particular below 100° C., and particularly preferably below 80° C. Adding the auxiliary solvent 56 to the low-binder black mass 42′ produces a mixture 60. The auxiliary solvent 56 and the binder solvent 46 are separated from each other, for example by means of a distillation device 62.

It is possible to use a substance of the conducting salt solvent as the binder solvent 46, in particular the low-boiling fraction. In this case, the temperature T48 is preferably above T48=80° C., for example T48 ≥100° C. High temperatures are advantageous in order to wash out the binder 54 as efficiently as possible. In one embodiment, the washing out of binder 54 is therefore carried out at a positive pressure, so that the washing out can be carried out at a temperature above the boiling point of the binder solvent. For example, for the pressure p48 in the washing out vessel 48 p₄₈≥1500 hPa.

In an optional step S8, black mass 42′ is dried. This is preferably done at a temperature of at most 80° C. and under a pressure of at most 300 hPa, for example at most 100 hPa. Dryer 36 can be used for this.

Subsequently, in an optional conducting salt washout system 64, in accordance with an optional step S9, conducting salt or the anion of the conducting salt is washed out of the black mass 42′ by means of an aqueous liquid 66. In this way, black mass with a low fluorine content and, in particular, a low binder content is obtained.

Due to the low binder content, a graphite fraction 70 of the black mass 42′ can be easily separated in a step S10 in a separating device 68 from a metal-compound particle fraction 72. The metal-compound particle fraction 72 consists of particles in which metal compounds are concentrated. For example, NMC (nickel-manganese-cobalt) particles are enriched in metal-compound particle fraction 72.

The metal components of metal-compound particle fraction 72 are preferentially extracted hydrometallurgically, for example by precipitation or by solvent extraction.

FIG. 2 shows a schematic view of a rechargeable battery processing system 8 and a method according to the invention. After short-circuiting according to step S1, the at least one rechargeable battery 10 is comminuted in step S2 to form the comminuted material 18. This is dried in the dryer 36. After that, the plastic components 40, in particular plastic foil parts and/or metal foil parts, are separated, so that the black mass 42 is obtained. The conducting salt solvent, in particular the high-boiler fraction, is then washed out of the black mass 42. After that, the binder is washed out. Optionally, the binder solvent is then washed out. Subsequently, the black mass is dried and the conducting salt is washed out with the aqueous liquid. After that, the graphite fraction 70 and the metal compound particle fraction 72 are separated again.

FIG. 3 shows a schematic view of a rechargeable battery processing system 8 and a method according to the invention, in which, after short-circuiting and crushing the rechargeable batteries, the conducting salt solvent, in particular the high-boiler fraction, is first washed out. After that, the comminuted material is dried in order to be able to separate the plastic parts 40 more easily in the subsequent step.

After that, the conducting salt is washed out of the resulting black mass 42 using an aqueous liquid, and the black mass 42 is then optionally dried. Since the black mass 42 then contains hardly any conducting salt, drying can also be carried out at a drying temperature of more than 100° C. This causes the aqueous liquid to evaporate. The binder is then washed out and, optionally, the binder solvent is removed by washing out. After drying, the graphite fraction 70 can then be separated from the metal compound particle fraction 72.

FIG. 4 shows a schematic view of a rechargeable battery processing system 8 and a method according to the invention, in which the plastic parts, in particular plastic foil parts and/or metal foil parts, are separated after short-circuiting and comminuting the rechargeable batteries and drying the comminuted material. After that, the conducting salt solvent is washed out and the black mass is then dried. After that, the conducting salt is washed out, the black mass is dried if necessary and then the binder is washed out. Optionally, the binder solvent is then washed out, dried if necessary and then the graphite fraction 70 and metal compound particle fraction 72 are separated.

FIG. 5 shows a further embodiment of a process according to the invention, in which, after discharging, optionally short-circuiting according to step (a) of claim 1, the at least one rechargeable battery is comminuted. The comminuted material 18 is then dried, and the plastic foil parts are separated from the dried comminuted material obtained in this way. Drying is preferably carried out at a pressure of at most 300 hPa, in particular 100 hPa, preferably at most 10 hPa. The temperature during drying is preferably at most 70°, in particular at most 60°, preferably at most 50°.

After that, the binder and the conducting salt solvent are washed out together. This can be done, for example, by means of the low-boiling fraction of the conducting salt solvent of the rechargeable batteries at a temperature of at least 70° C., preferably at least 80° C., particularly preferably at least 90° C., especially at least 100° C., for example at least 110° C. The temperature is below the boiling point at the corresponding pressure. The pressure may be normal pressure, i.e. ambient pressure, or a positive pressure. For example, the pressure is at least 1.5 bar, in particular at least 2 bar, for example at least 3 bar. The pressure is usually less than 150 bar, in particular 100 bar. Alternatively, the binder and the conducting salt solvent are washed out using an organic solvent that is not part of the conducting salt solvent, for example using dimethyl sulfoxide.

The black mass can then be dried, but this is not necessary. In a subsequent step, the conducting salt is washed out using an aqueous liquid. The graphite fraction and the metal compound particle fraction are then separated from each other.

### LIST OF REFERENCE SIGNS

8 rechargeable battery processing system
10 rechargeable battery
12 galvanic cell
14 discharger
16 rechargeable battery comminution system
18 comminuted material
20 conduit
22 high-boiler fraction washout device
24 high-boiler fraction
26 high-boiler fraction solvent
28 vessel
30 high boiler/solvent mixture
32 regeneration device
34 line
36 dryer
38 plastic separating device
40 plastic components
42 black mass
44 binder washout device
46 binder solvent
48 washout vessel
50 binder/solvent mixture
52 recovery system
54 binder
56 auxiliary solvent
58 vessel
60 mixture
62 distillation unit
64 conducting salt washout system
66 aqueous liquid
70 graphite fraction
72 metal-compound particle fraction
TS,t separation boiling point
Tₖ short-circuit time
U_{reg} regeneration cell voltage

1-14. (canceled)

15. A method for recycling rechargeable batteries, in particular lithium rechargeable batteries and/or sodium rechargeable batteries, each consisting of at least one galvanic element, each having two poles, and containing a conducting salt dissolved in a conducting salt solvent, comprising the steps of
(a) comminuting the rechargeable batteries by means of a rechargeable battery comminution system to obtain comminuted material
(b) washing out a high-boiler fraction of the conducting salt solvent from the comminuted material by means of a high-boiler fraction solvent, so that a high-boiler/solvent mixture and comminuted material low in high-boilers is obtained
(c) washing binder using a binder solvent
(d) supplying the binder solvent to the comminuted material
(e) withdrawing the binder/solvent mixture, and
(f) separating the binder solvent and returning it to the comminuted material.

16. The method according to claim 15, wherein separating the binder solvent is done by
(a) evaporation and/or
(b) vacuum distillation and/or
(c) separating binder, which is done by
(i) reducing the temperature and subsequent filtration, centrifugation or sedimentation,
(ii) drawing the binder off and
(iii) reusing the remaining binder solvent for washing out binder or drawing it off.

17. The method according to claim 15, wherein the steps after comminuting, separating plastic parts and/or metal foil parts

18. The method according to claim 15, wherein at least 1 liter of binder solvent are added per kilogram of black mass to wash out binder, the black mass having resulted from separating plastic parts and/or metal foil parts.

19. The method according to claim 15, wherein the steps after washing out the binder, drying the comminuted material or black mass.

20. The method according to claims 15, wherein the steps after washing out the binder, washing out of the binder solvent by means of an auxiliary solvent having a lower boiling point than the binder solvent (46)

20. The method according to claim 15, wherein the steps short-circuiting the rechargeable batteries until at least 75% of the galvanic elements have a regeneration cell voltage of at most 0.3 volts, in particular at most 0.2 volts, before comminuting the batteries.

21. The method according to claim 15, wherein washing out conducting salt solvent by means of the low-boiler fraction of the conducting salt solvent, is carried out at a temperature of at most 80° C.

22. The method according to claim 15, wherein
(a) the binder solvent consists of at least 50 percent by weight of substances which are components of the conducting salt solvent and/or
(b) the washing out of the binder is carried out at a temperature of at least 80° C., in particular at least 90° C.

23. The method according to claim 1, wherein the step of after removal of the binder, washing out conducting salt by means of an aqueous washing solvent

24. A rechargeable battery processing system for recycling rechargeable batteries, in particular lithium rechargeable batteries and/or sodium rechargeable batteries, each consisting of at least one galvanic element, each having two poles, and containing a conducting salt dissolved in a conducting salt solvent, having
(a) a rechargeable battery comminution system for comminuting the rechargeable batteries to obtain comminuted material,
(b) a high-boiler fraction washout device for washing out a high-boiler fraction of the conducting salt solvent by means of a high-boiler fraction solvent, so that a high-boiler/solvent mixture and comminuted material with a low content of high boilers are obtained,
characterized by
(c) a binder washout device, which is arranged downstream of the rechargeable battery comminution system in the direction of material flow and is designed to wash out binder from the comminuted material by means of a binder solvent, so that comminuted material with a low content of high boilers is obtained, and
(d) wherein the binder washout device has a recovery plant for recovering binder solvent.

25. The rechargeable battery processing system according to claim 24, wherein the high-boiler fraction washout device has a regenerating device for regenerating the high-boiler fraction solvent.

26. The rechargeable battery processing system according to claim 24, wherein
(a) a dryer arranged downstream of the high-boiling fraction washing device in the direction of material flow, and
(b) a plastic separator arranged downstream of the dryer and upstream of the binder washing device for separating plastic parts, in particular plastic foil parts.

27. The rechargeable battery processing system according to claim 24, wherein a conducting salt washout system for washing out conducting salt by means of an aqueous liquid, which system is arranged downstream of the binder washout device in the direction of material flow and upstream of a separating device.

28. The rechargeable battery processing system according to claim 27, wherein the separating device is designed to separate a graphite fraction from a metal compound particle fraction of the comminuted material.

29. The rechargeable battery processing system according to claim 24, wherein a wet-chemical processing system arranged downstream of the separating device in the direction of material flow for wet-chemically extracting at least one metal component from the metal compound fraction.
